(19) United States
(12) Patent Application Publication
(10) Pub. No.: US 2015/0265972 A1
(43) Pub. Date: Sep. 24, 2015

(54) PARALLEL TUBULAR MEMBRANES WITH RESILIENT WIRE SUPPORT STRUCTURE

(71) Applicant: X-Flow B.V., Enschede (NL)

(72) Inventors: Hendrik Dirk Willem Roesink, Hertme (NL); Ingo Blume, Hengelo (NL); Bastiaan Blankert, Enschede (NL); Marinus Hendrikus Olde Weghuis, Oldenzaal (NL)

(21) Appl. No.: 14/621,841

(22) Filed: Feb. 13, 2015

Related U.S. Application Data
(63) Continuation of application No. PCT/NL13/50600, filed on Aug. 15, 2013.

(30) Foreign Application Priority Data
Aug. 16, 2012 (NL) 2009330

(51) Int. Cl. B01D 63/06

(52) U.S. Cl. CPC B01D 63/06; B01D 2311/2665; B01D 2319/04; B01D 2313/42; B01D 2313/40

(57) ABSTRACT

A filter module comprising a plurality of essentially parallel tubular membranes, the tubular membranes comprising a porous tube wall that functions as a filtering membrane, wherein the module comprises a support structure for supporting the tubular membranes, the support structure comprising an open three-dimensional network of stable shape consisting of stiff wires or fibers, the support structure being shaped such that it comprises open parallel tubes or parts of tubes that envelope each of the tubular membranes at least partly over at least a part of its length, in such a way that a tube or part of a tube of the support structure supports at least one tubular membrane.

### CROSS-REFERENCE TO RELATED APPLICATIONS

This application is a continuation application of Patent Cooperation Treaty Application No. PCT/NL2013/050600, filed on Aug. 15, 2013, which claimed priority to Netherlands Patent Application No. 2009330, filed on Aug. 16, 2012, and the specification and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention (Technical Field):

The present invention relates to a filter module comprising a plurality of tubular membranes that are extending essentially parallel to each other, and the tubular membranes comprising a porous wall that functions as a filter.

2. Description of Related Art:

Such filter modules are known. They are widely used in filtration devices and systems based on membrane filtration. In such units the membranes are formed by porous tubular membranes that usually have an essentially cylindrical external shape and are defining a cylindrical cavity. The walls of the membranes are forming a filtering membrane between the cylindrical cavity and the outside of the membranes. Filtering installations use such membranes in large quantities and thus creating a large total membrane area in which a fluid can be filtered by separating the internal cavities of the membranes from its outside. Thus it is possible to either supply a fluid to be filtered to the outside of the membranes and the filtering action of the membranes will produce the filtrate in the internal cavities. The filtrate is then collected from the cavities of the tubular membranes and discharged from the filtering apparatus. This is called filtering outside-in. It is also possible to exchange the position of the fluid to be filtered in the filtrate by supplying the fluid to be filtered to the cavities of the tubular membranes and collecting the filtrate at the outside. This is called inside-out filtration.

An effective execution of such filtering apparatuses comprise filter units that consists of an large multitude of membranes of a certain often equal length wherein those membranes are connected together at a relatively short distance of each other and the ends are kept together by having them potted in a block of a resin. Thus the membranes are being transformed to blocks of membranes and at the end a clear separation is maintained between the internal cavities of the tubular membranes and the outside of the membranes. This way the fluid to be filtered is kept separate from the filtrate in the case of outside-in filtration as well as the case of inside-out filtration. Often filter apparatuses comprise a multitude of such modules of potted tubular membranes.

There is a certain advantage in outside-in filtration over inside-out filtration. The advantage being that more membrane area per module is provided to the fluid to be filtered. However, outside-in filtration also has certain disadvantages. The fouling of the fluid to be filtered accumulates in a poorly defined geometrical structure. At locations where the membranes are close to each other, the fouling layer can stick between two membranes. To remedy this, usually air scouring is used which results in mechanical stress on the membranes as the air scouring relies on shaking the membranes to remove the fouling between them. Also air scouring requires energy consumption and usually also some consumption of chemicals.

When considering outside-in filtration there are two possibilities to supply the fluid to be filtrated to the outside of the membranes, the so called parallel flow and the so called perpendicular flow (also called transversal or true cross flow). In parallel flow the fluid is flowing along the membranes in the direction parallel to the central axis of the membranes and in perpendicular flow the fluid to be filtrated flows perpendicular to the central axis of the membranes. In parallel flow the fluid to be filtrated has to enter a filtration module through the potting of the module. Here the membranes are rigidly held together and thus it is hard to obtain a good distribution of the fluid to be filtered. The same holds for air in the case of air scouring. It has, however, been shown that outside-in filtration in the perpendicular flow configuration has advantages compared to the parallel flow configuration, see, e.g., “The Transverse Flow Membrane Module: Construction, Performance and Applications”, Futselaar, H. 1993. ISBN, 9090061932 and Microfiltration: Membrane development and module design, Roesink H. D. W, 1989, ISBN 909002843-9. Flow perpendicular to the membrane is better able to remove fouling compared to parallel flow. By feeding perpendicular to the membranes a better distribution of the feed fluid can obtained and an optimized mass or heat transfer is achieved. However, perpendicular flow also has some disadvantages. Usually the membranes are placed horizontally. Due to expansion (wetting, temperature) the membranes may expand and ‘hang’. This may cause the membranes to touch each other, which increases the fouling potential and reduces mass transfer. Another unwanted effect is increased possibility for membrane breaking due to high forces at the exit points where the membranes leave the resin potting. Also in case the membranes are placed vertically, they may contact each other with a similar negative effect. Furthermore this may cause mechanical stress on the interface between the membrane and the potting. Consequently the length of the membranes is limited. Thus a relatively large area is lost due to potting and also the modules are complicated to fabricate because there is relatively much potting.

Examples of filter units with a multitude of tubular membranes placed horizontally are known from U.S. Pat. No. 5,232,593 and from U.S. Pat. No. 4,959,152. U.S. Pat. No. 5,232,593 describes a module wherein a stack of framed tubular membranes is arranged on top of each other to form a transverse module. U.S. Pat. No. 4,959,152 describes a separation module build up by sheets or mats of tubular membranes stacked on top of each other. The sheets or mats being formed by tubular membranes that at their ends are held in a frame. A useful length of membranes described in U.S. Pat. No. 5,232,593 and U.S. Pat. No. 4,959,152 is limited to a maximum of 40-50 cm due to the problems described above.

EP 0 345 983 describes a fluid treating apparatus of hollow fiber type such as being used for blood dialyzers, artificial lungs, plasma separators and the like. Mats of hollow fibers are formed by warps of cord-fabric-like type, holding the fibers together and parallel to each other. The lengths of fibers discussed in the applications are 10 cm and thus an order of magnitude smaller than is desirable in filter units. The warps do not provide added support to the fibers other than holding them together and are not suitable for longer fires as required in filter units.

U.S. Pat. No. 6,271,023 describes a filter unit for filtering different fluids in one step. Fibers for filtering the different fluids are separate to common inlets and outlets. The concept of weaving mats of fibers using warps, like in EP 0 345 983, is also mentioned here.

### BRIEF SUMMARY OF THE INVENTION

It is an aim of the present invention to overcome the disadvantages that have been mentioned in relation to outside-in filtration in combination with perpendicular flow. It is another aim of the invention to provide other advantages which will be further described below.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIGS. 1a and 1b are schematic views in cross section of a support structure with tubular membranes respectively in a first and a second configuration;

FIG. 2 is a schematic view of a part of the support structure;

FIG. 3 is a top view of a configuration of FIG. 2;

FIG. 4 is a schematic view in cross section of stapled configurations of FIG. 1;

FIG. 5 is a schematic side view of a horizontal potted membrane and support structure;

FIG. 6 is a the view of FIG. 4 with aeration tubes; and

FIG. 7 is an example of the configuration of Fig. la with stiffening bars.

### DETAILED DESCRIPTION OF THE INVENTION

These aims are fulfilled by a filter module comprising a plurality of tubular membranes that extend essentially parallel to each, the tubular membranes comprising a porous wall that functions as a filter, wherein the module comprises a support structure for supporting the tubular membranes, the support structure comprising an open 3-dimensional network of self-supporting stable shape, formed by resilient wires or fibers the support structure being shaped such, that parallel open tubes or parts of tubes are formed by the network that at least partly envelops and supports each of the tubular membranes over at least a part of the length of its cylindrical exterior, such that a tube or part of a tube of the support structure supports at least one tubular membrane. The support structure is stiff enough to span a large distance without bending. The wires or fibers forming the network are resilient and thus exhibit a certain stiffness themselves. That is, stiffness being a relative property, stiff enough to give the support structure a stable shape, meaning that the wires or fibers are resilient or elastic and flexible, and thus are able to resist not only tensile forces but also bending and compressive forces as opposed to, e.g., fabric threads that are able to resist tensile forces only. In addition to stiffness from the wires or fibers themselves, stiffness of the support structure as a whole is largely obtained by the 3D structure of the network. Crossing wires or fibers at nodal points of the network are fixed relative to each other by various possible means such as friction or bonding, etc. The membranes are supported by the support structure and thus membranes of considerable greater length may be used without experiencing the abovementioned problems of the membranes hanging or even breaking. The distance between the membranes is controlled and the membranes cannot touch. Movement of the membranes is prevented. In this way full advantage can be taken from the good properties of outside-in filtration in combination with perpendicular flow, without suffering from the disadvantages of this combination in existing filtration units. It is emphasized here that the cross section of the parallel open tubes or parts of tubes of the support structure are not limited to a circular cross section and can have a cross section of any shape. The tubular membranes usually have an essentially cylindrical external shape with the understanding that the surface lines may be smooth or corrugated (convoluted) in either longitudinal or transversal direction.

The support structure can be obtained in different ways. In one preferred embodiment, the network is formed by weaving or braiding of the elastic flexible wires to a network of the desired shape. In another preferred embodiment, the network is formed by smelt deposition of fibers to a network of the desired shape.

The stiffness of the support structure in the direction of the central axis of the parallel tubes may be increased by connecting each tube with at least one adjacent tube, the connection being part of the network. This connection can be such that the connected tubes are directly connected or connected in a way that they are spaced apart. This way a bending force on a tube of the support structure is distributed over several tubes of the structure, thus increasing the bending force that may be absorbed by the support structure.

It is possible to have such a connection in different ways where each way can bring a separate advantage. It is also possible to combine different connections all being part of a support structure according to the invention. The connection can be essentially lying in a plane formed by the longitudinal axis of two adjacent tubes. The connection can also be provided by a first network surface defining a plane of the support structure to which a plurality of parallel network tubes of the support structure has been attached. This first network surface itself adds to the stiffness of the support structure, notably in all directions lying in the plane defined by the first network surface. The connection can also be formed such that in addition to said first network surface there is a second network surface, defining a plane essentially parallel to the plane defined by the first network surface, such that a plurality of parallel tubes are located between and attached to both the first and the second network surface.

With advantage the support structure is arranged in such a way that it contains a plurality of layers of such network surfaces defining essentially parallel planes, wherein between each two adjacent layers of parallel network surfaces, layers of parallel tubes are attached. This way it is possible to create in an easy way a plurality of layers of tubular membranes of which the shape is retained by a support structure.

Another advantage can be taken of the presence of the support structure according to the invention by using some of the tubes of the support structure for hosting aeration tubes so that these aeration tubes can be spread in a purposeful way throughout the module.

Also some tubes of the support structure can be used to contain stiffening rods. In this way the stiffness of the filter module in the direction of the longitudinal axis of the tubular membranes is even more increased.

The embodiment of the invention with the woven or braided support structure is made of resilient and hence elastic flexible wires or fibers. This means that the wires or fibers of which the structure is comprised may be bend but due to the elasticity tends to return to the unbend position. It also means that dependent on the way the wires or fibers have been woven or braided, certain parts of the support structure may bend easier in a certain direction whereas those same parts are very stiff in another direction. Also certain parts are resisting bending in any direction, such as the tubes that can be made to be stiff in all directions due to their 3D shape and depending on the way they are woven or braided. With advantage the wires are made of a thermoplastic material. This material is typically suitable to produce support structures with the desired properties as describes above. Examples of these structures can be found in the industry under headings such as 3D hollows, 3D mesh or 3D spacer fabric. A typical example for a suitable structure as intended for use in this application is for example the spacer fabric, known under the trade name Nicolon™, as produced by Ten Cate, Nijverdal, The Netherlands.

In another embodiment of the invention, the network of the support structure comprises wires or fibers that have been joined at nodal points by being molten, welded or glued together. This can be the case with a woven or braided network of the support structure where the joining of the wires at the nodal points gives the nodal points additional strength. However it is also possible that the network of the support structure is produced by joining wires melting, welding or gluing them together at nodal points without the wires being woven or braided. The desired 3D shape can then, e.g., be obtained by performing the joining operation using a suitable mold and die configuration.

Requirements on filter apparatuses may vary widely depending on the application. In such an application it is important that the openness of the network is relatively large, for instance to allow a good flow along the tubular membranes. Openness of the network being defined as open surface area as a percentage of total surface area. However, the opposite can also be a requirement, for instance in Membrane Bio Reactors (MBR) or in Waste Water Treatment Plants (WWTP), where it is an advantage when sludge is formed and the sludge is immobilized between the membranes. The network meshes of the support structure of the invention may then be dimensioned such that e.g. at certain points sludge is immobilized by the network by using a sufficiently small mesh while at other points the network mesh is dimensioned larger to allow fluid including sludge to pass easily. That way less sludge is pumped around through the system which results in less shear on the sludge which is an issue in current Membrane Bio Reactors and also the fouling potential of the water is smaller.

In yet other advantageous embodiments of the invention, the presence of the support structure is used to add functionality to the filter modules according to the invention by adding an active agent to the material of the support structure. This agent may, e.g., be mixed with the source material or may be added as a complete or partial coating to the wires or fibers of the network. Active agents may be selected from the group comprising a biocide, a catalyst, an adsorbent, an ion-exchange resin, an oxidant, a disinfectant, an antimicrobial agent, of combinations of these.

The invention relates equally to filter installations that comprise one or more filter modules according to the invention. The many advantages of filter installations according to the invention are described below with examples of various embodiments of filter modules in filter installations according to the invention, referring also to the drawings.

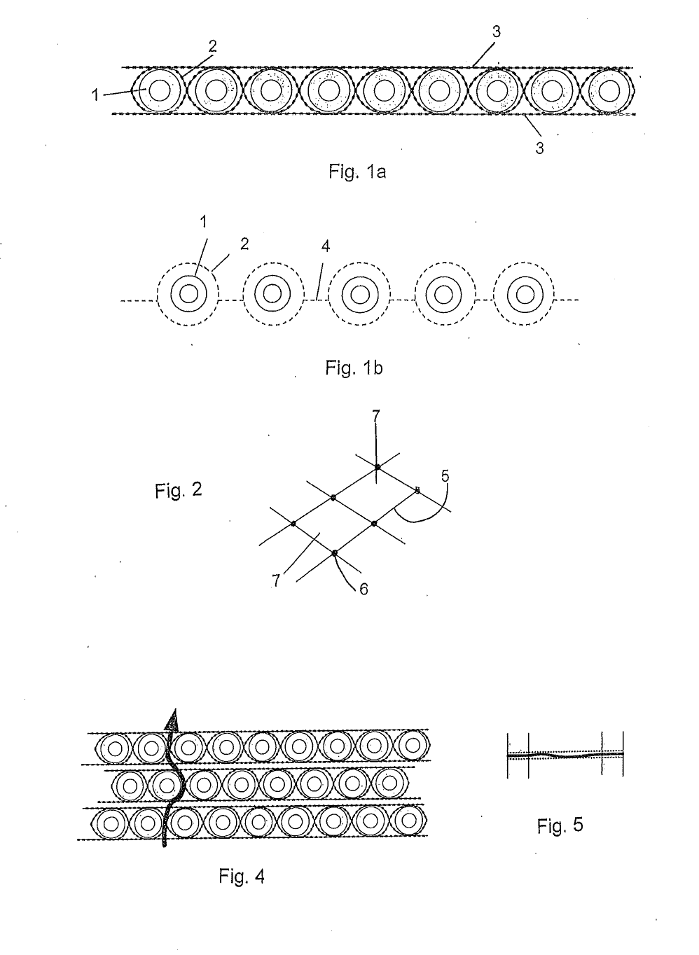

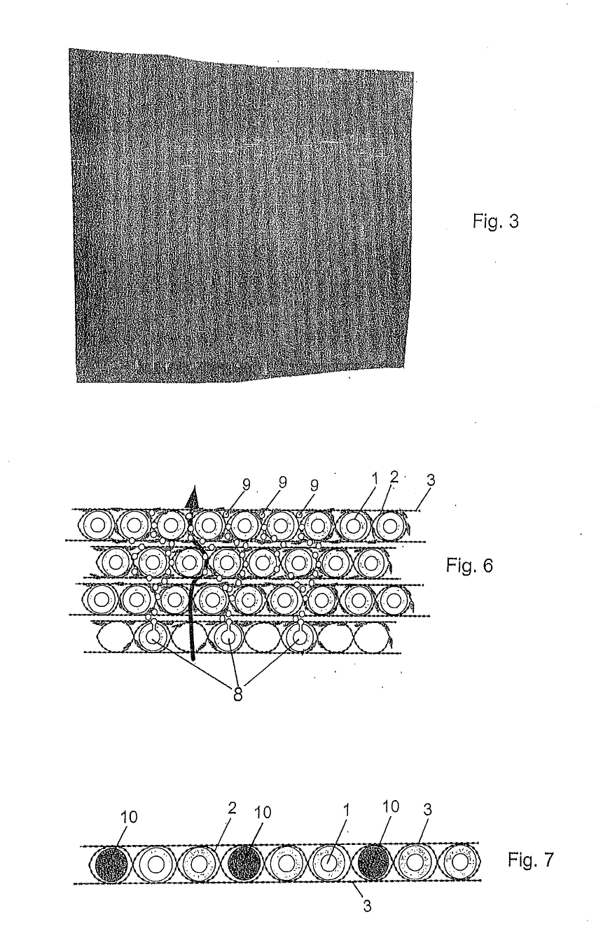

In FIGS. 1a and 1b two possible configurations are shown in schematic view in cross section of a support structure with tubular membranes. The tubular membranes of which only one is indicated with reference number 1 in both FIGS. 1a and 1b are the porous membranes that are forming the filters of a filter module. The support structure is formed by a network comprising an open woven three-dimensional network of stable shape. Tubular membranes 1 are embedded in tubes 2 formed by the woven network of the support structure. In the embodiment of a filter unit according to the invention described here, each tube 2 of the support structure is carrying only one tubular membrane 1. The invention encompasses also embodiments where more than one tubular membrane is carried in each tube 2 of the support structure. In both FIGS. 1a and 1b only one of the tubes 2 carrying the tubular membranes 1 is indicated with reference number 2 in order to maintain clarity in those two figures. In FIG. 1a the tubes 2 of the support structure are laying between two essentially planar network surfaces 3 also part of the woven network of the support structure. In the support structure as shown in FIG. 1b the tubes 2 are connected and spaced apart by connecting parts 4 of the support structure. Connecting parts 4 are connecting two adjacent tubes 2 and are also formed by and part of the woven network. The woven network of connecting parts 4 is at connection points fixed to the woven network of the tubes 2. The woven network of the support structure is formed by resilient and thus elastic flexible wires 5 exhibiting a certain stiffness and the wires are woven to form a network and the wires are fixed to each other at nodal points 6 of the net. The wires can be fixed to each other at the nodal points by friction of the weave, but they may also either in addition or as alternative be fixed to each other by a joining method such as welding, gluing etc. This is schematically illustrated in FIG. 2 where three parallel wires 5 in one direction are intersecting two wires 5 in another direction at nodal points 6. Of the wires only two have received the reference number 5 and only one nodal point 6 is shown with the reference number 6 in FIG. 2. The elastic flexible wires or threads can be wires from a suitable plastic material that are unified at the nodal points. The woven network thus formed to the three dimensional support structure can form for instance very stiff tubes 2 connected by connecting parts 4 that are very flexible at least in one direction. Thanks to the structure of the wires 5 connected at nodes 6 the structure can be much stiffer than the stiffness provided by the stiffness of the wires themselves. An example of a configuration shown in FIG. 1a is shown in FIG. 3. Here it is rather clear that the tubes 2 are surrounding tubular membranes 1, giving the membranes good support but the tubes 2 are still quite open to let fluid to be filtered pass through the support structure to get to the membranes 1 and allow membranes 1 to filter the fluid.

The membranes 1 with the support structure can now be composed to form filter units containing many membranes 1. If the membranes are carried by a support structure as indicated in FIG. 1a such filter units can be built up by having several layers as indicated in FIG. 1a being put on top of each other. Such layers can have varying widths in order to create a total shape which needs not to be rectangular. FIG. 4 shows an example where three layers as indicated in FIG. 1a are being shown on top of each other. The membranes and the support structure can be spanning a large distance without bending because the support structure is stiff enough. If there is a small amount of play for the membranes 1 within the tubes 2 of the support structure, this is quite permissible because the support structures will prevent membranes 1 to be touching each other and will also prevent the membranes from hanging through more than this may allowed by the play they have within their tubes 2. A support structure with tubular membranes 1 as shown in FIG. 1b, allows itself to be rolled up and thus rolls of membranes in the support structure can be formed to approximately cylindrical units.

In this way it is made easy to have horizontal membranes of considerable length as part of the filter units. This facilitates outside-in-filtration.

It should be noted here that the meshes that are formed by the network may differ in their size as well as in the shape in various parts of the network. Size and shape of the meshes can be changed to influence the openness of the network as well as the stiffness in the directions that lie in the surface that is formed by the network. Clearly a variation in stiffness can be obtained by varying the shape of the woven network, the size and shape of the meshes as well as the material and the thickness of the wires that are forming the network. This has been mentioned above in describing the configuration of FIG. 1b. The support structure is required to be very stiff in the tubes 2 but flexible in connecting part 4 in a direction perpendicular to the plane that is defined by connecting part 4, so that the support structure allows itself to be rolled up rather easily but resists deformation of the tubes 2. It is also clear from what has been said above that that plane does not have to be flat but can be curved. Variation of the openness may be wanted in applications of filtration where the fluid to be filtered comprises sludge. Reducing the areas of meshes 7 will increase the possibility that the support structure traps this sludge. This trapping of sludge does have advantages in that less sludge is pumped around through the system.

As is shown in FIG. 6, the support structure according to the invention cannot only be used to support tubular membranes 1 in tubes 2 but certain tubes 2 can be used to carry aeration tubes 8 instead of tubular membranes 2. These aeration tubes 8 are used to send air through the filtration unit to clean the unit from clogged particles that have got stuck in the filtration unit. FIG. 6 shows three of such aeration tubes 8 being placed upstream of the unit and aeration tubes 8 are provided with openings to let out air that is being blown into the aeration tubes 8. The air bubbles 9, three of those bubbles have been provided with reference number 9 only for clarity sake, are passing through the system and may loosen particles that have become stuck and transport them out of the system.

Another use of the support structure of the tubular membranes 1 according to the invention, as is shown in FIG. 7, is to replace in some of the tubes 2 of the support structure the tubular membrane 1 by a support bar 10 to increase the stiffness of the filtration unit. This could for instance be the case in a filtration unit that requires a very large openness of the network in combination with very long heavy tubular membranes. This may lead to a support structure of a network woven with relatively thin wires 6. In such a case the stiffness of the support structure might not be sufficient and need to be increased and this can be done by using some of the tubes 2 of the support structure to carry support bars 10 to increase the stiffness.

With filter modules according to the invention comprising support modules it becomes feasible to compose filter modules of considerable length, with tubular membranes of 1 m and longer. These filter units may be subjected to high output conditions like strong perpendicular flow with horizontal membranes without risk that the membranes will touch each other or that the membranes get damaged at their point of fixture (potting).

This type of module can find use in all sorts of separation applications and problems, as it offers possibilities to build larger modules, possibilities to operate perpendicular flow module more economically and finally enables one to more effective and economical process designs. For example, these modules can be used in solid-liquid separation, such as ultra, micro or nano filtration applications for the removal of particles, bacteria, viruses, but also proteins, and many more compounds from aqueous (but not limited hereto) feed streams. Process designs can be based on all types of filtration modes, being gravity filtration, pressure filtration or suction filtration.

In a second field this type of module can find use in solid-gas separation problems, e.g., the removal of particulates, bacteria or any other solid from gas or vapor streams.

In a third area of separation, this module can find advantageous use in desalination applications, such as osmosis, reverse osmosis, pressure retarded osmosis and/or forward osmosis.

Another area of application is the use of this type of modules for gas-vapor separations. An example hereto might be the (de)humidification of gas feeds or air, or in general the humidity control of any gas feed stream.

Another use is in the separation of liquid or gas-vapor streams using process designs for vapor permeation or pervaporation.

Yet another field of application is the use of these modules as contactors in for example the removal of condensable vapors from industrial gas streams. An example hereto might be the removal of acid gases or the removal of water vapor from flue gas streams. In principal these contactors can be used in any kind of extraction application.

### LIST OF REFERENCE NUMBERS

1 tubular membrane

2 open tube of support structure

3 planar surface of support structure

4 network connecting tubes 3

5 wire of the support structure

6 node of wires 5

7 mesh

8 aeration tube

9 air bubble

10 support bars

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A filter module comprising a plurality of essentially parallel tubular membranes, the tubular membranes comprising a porous wall that functions as a filtering membrane, wherein the module comprises a support structure for supporting the tubular membranes, the support structure comprising an open three-dimensional network of self-supporting stable shape formed by resilient wires or fibers, the support structure being shaped such that it comprises open parallel tubes or parts of tubes, that envelope each of the tubular membranes at least partly over at least a part of its length, in such a way that a tube or part of a tube of the support structure supports at least one tubular membrane.

2. The filter module according to claim 1, wherein the network comprises woven or braided wires.

3. The filter module according to claim 1, wherein the network comprises bonded wires or fibers.

4. The filter module according to claim 1, wherein in the support structure each of the parallel open tubes is connected with at least one adjacent tube, the connection being part of the open network of stable shape.

5. The filter module according to claim 4, wherein the connection is arranged such that adjacent tubes of the support structure are spaced apart.

6. The filter module according to claim 1, wherein the support structure comprises a first network surface defining a plane, on which a multitude of parallel open tubes is arranged, the network of the tubes being coupled to the network of the network surface.

7. The filter module according to claim 6, wherein the support structure comprises a second network surface defining a plane essentially parallel to the plane defined by the first network surface, in such a way that the network of the plurality of parallel tubes is coupled to the network of both the first and the second surface.

8. The filter module according to claim 6, wherein the support structure comprises a plurality of layers of network surfaces defining essentially parallel planes, wherein between each of two adjacent of these layers parallel tubes of the network are arranged.

9. The filter module according to claim 1, wherein the module comprises aeration tubes, which each are comprised in a tube of the support structure.

10. The filter module according to claim 1, wherein the module comprises reinforcing rods that each are comprised in a tube of the support structure.

11. The filter module according to claim 1, wherein wires of the network are thermally bonded in nodal points of the network.

12. The filter module according to claim 1, wherein the network comprises a thermoplastic material.

13. The filter module according to claim 1, wherein the network comprises an average surface openness of more than 20%.

14. The filter module according to claim 1, wherein the network meshes of the support structure are dimensioned such that it at least partly immobilizes sludge.

15. The filter module according to claim 1, wherein the material of the network comprises an active agent selected from the group consisting of a biocide, a catalyzer, an absorbent, an ion-exchange resin, an oxidant, a disinfectant, an antimicrobial agent, and combinations of these.

16. A filter installation, wherein the installation comprises one or more filter modules according to claim 1.
